(19) United States
(12) Patent Application Publication
(10) Pub. No.: US 2010/0082520 A1
(43) Pub. Date: Apr. 1, 2010

(54) METHOD AND SYSTEM FOR BUILDING A LANGUAGE FOR A KNOWLEDGE BASE

(76) Inventors: Denis Pierre, Murviel Les Montpellier (FR); Clement Durand-Daubin, Montpellier (FR); Christophe Fagot, Montpellier (FR)

Correspondence Address: YOUNG & THOMPSON, 209 Madison Street, Suite 500, Alexandria, VA, 22314, US

(21) Appl. No.: 11/993,497

(22) PCT Filed: Jun. 20, 2006
(86) PCT No.: PCT/FR06/01390

§ 371 Date: Dec. 21, 2007

(30) Foreign Application Priority Data
Jun. 21, 2005 (FR) 0506260

(51) Int. Cl. G06N 5/02

(52) U.S. Cl. 706/50; 706/55

(57) ABSTRACT

A method for building a language for a knowledge base correspondingly to the observation of facts in the world includes describing by a user a world representation by building an ontology, translating the description into restrictions corresponding to the user's prescriptions, observing errors between objects and actions present in an environment and in the prescriptions, and adapting the ontology or the system behaviour in such a way that the errors are moved off.

This invention relates to a method for building a language for a knowledge base, matched to the observation of facts in a world or context. It also mentions a system for the implementation of this method.

The implementation of a software tool devoted to a specific context or business generally proves very complex if this business or this context conceals a number of particular features involving very considerable expertise in the field and in its practices. One example of this is in the field of legal business, if the objective is to design a software tool to assist with drawing up a contract. The medical field could also be quoted if this involves designing a tool to help with diagnosis. Other professional fields could be listed to show how it can be difficult and costly to develop a “business” software tool which is at the same time high-performing and ergonomic.

In order to attempt to rationalize the approach to designing a software tool which is generally based on a knowledge base, techniques are already known for building knowledge representations systems which implement ontologies.

Accordingly, the document US 2004/0 220 969 (Cho et al.), which discloses methods for building and maintaining knowledge representation systems which are organized in the form of ontologies, as well as the document US 2003/0 126 136 (Omoigui), which discloses a system and a method for presenting, supplying, managing and recovering the knowledge, can be mentioned.

However, current techniques for building knowledge representation systems come immediately into contact with the problem of the absence of genericity and are actually restricted and limited to a business or a context for which they were developed. An objective is therefore set to propose a simple and high-performing technical solution to design software tools devoted to businesses or knowhows in all fields.

This objective is achieved with a method for building a language for a knowledge base, matched to the observation of facts in a specific context or world, this method comprising:

a description by a user of a representation of said system, by constructing an ontology, said representation being based on a knowledge base,

a translation of this description into a network of constraints corresponding to instructions from the user,

an observation of objects and actions present in an actual environment of said system,

a confrontation of said observed objects with said instructions,

a detection of errors between the sequences of observed objects and the translation of the description into a network of constraints, and

an adaptation of the ontology or behaviour of said system so as to correct said errors,

said ontology thus adapted procuring for said user the knowledge base language.

With the method according to the invention, there is accordingly a particularly high-performing method for building a language for a knowledge base enabling to produce “business” software tools at lowest cost. This method of building can be implemented in any information system comprising one or more data and knowledge bases and workstations used by practitioners or professionals and from which objects and/or actions can be observed and collected.

The steps of description, translation and observation can be iterated while the observed errors are outside an acceptable error state.

If this method is implemented for the supply of a “business” software tool, the description step comprises building a practical reference system.

The building of a practical reference system can be accompanied advantageously by a definition of a semantic network consisting of terms, concepts and relationships.

The observation step can comprise an entry of information in real time on a user's workstation from said “business” software tool and/or a collection of information in one or more “business” databases.

According to another aspect of the invention, a system is proposed for building a language for a knowledge base matched with observation of facts in a system, so as to provide a software tool associated with said system, implementing the method according to the invention, comprising:

means for building, from a description of a representation of said system by a user, an ontology for the knowledge base,

means for translating this description into a network of constraints corresponding to instructions from the user,

means for observing objects and actions present in an actual environment of said system,

means for confronting said observed objects with said instructions,

means for detecting errors between sequences of observed objects and the translation of the description into a network of constraints, and

means to adapt the ontology or the behaviour of said system so as to correct said errors,

said ontology thus adapted procuring for said user the language for the knowledge base.

Other advantages and characteristics of the invention will appear on examination of the detailed description of an implementation mode, in no way limiting, and the attached drawings in which:

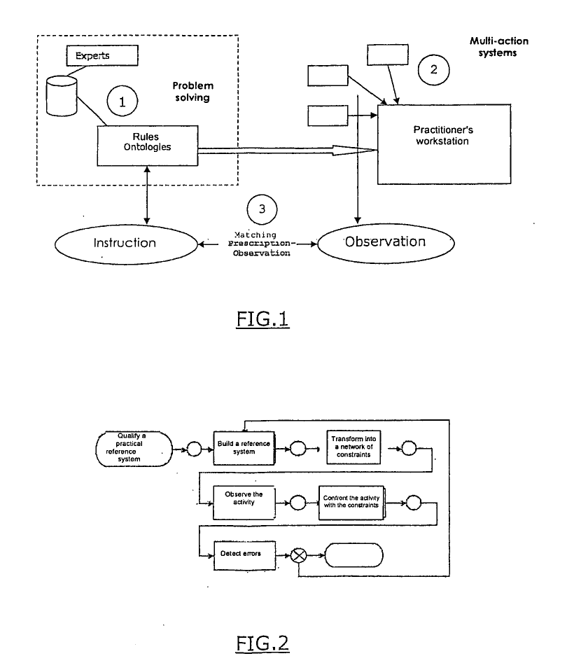

FIG. 1 illustrates schematically the general problem which is the background to the method according to the invention, and

FIG. 2 illustrates a process for defining and qualifying a reference system of practices implementing the construction method according to the invention.

The construction method according to the invention has its background in an original offer of a technical response to a growing demand in the field of solving complex problems encountered in information systems. By reference to FIG. 1, there is initially a definition (1) of a problem to be solved. From data collected from experts, rules and ontologies are established following techniques that are conventional or specific to the problem to be solved. These rules and these ontologies are implemented to produce software tools (2) which are provided to practitioners or operators on their workstations, either in resident mode, or in remote mode. These software tools implement a plurality of software applications, thus constituting a multi-action system.

Furthermore, the instructions resulting from rules and ontologies are confronted and compared (3) with observations made on different components of the information system, in order to produce a match between instructions and observations, and it is at this stage that the method for building a language according to the invention is implemented.

An embodiment of the method for building a language according to the invention will now be described. The field of medical diagnosis in cancerology is considered. In this context, a doctor must decide on a treatment in response to the description of a pathology, a history of the patient and the report from the current consultation. This treatment must conform to rules of good practice, drawn up, for example, by a learned society, a professional association or an institution.

The construction of these rules of good practice, or “reference system” of practices, is accompanied by the definition of a semantic network formed from terms, concepts and relationships. The terms are signifieds associated with “concept” or “relationship” signifiants. Each concept or relationship is placed in a tree structure and is represented by:

a definition: statement of the difference between a concept/a relationship and its parent,

a set of canonical forms: statement of the forms of use admissible for a concept/a relationship,

a set of prototypes: statements of prototype forms of a concept/of a relationship.

This is how, with the doctors, the concepts handled in connection with this activity (patient, treatment, stages, grades, etc.) and the relationships permitted between these concepts are defined. For example, these permitted relationships can be:

a patient has a set of earlier treatments,

the indicator of a stage bans a treatment,

a grade greater than a given value involves giving precedence to a particular treatment.

This is how the “semantics” of a practice are built while explaining its reference system. This representation can be transformed easily into a network of constraints defining, in another language, the relationships of involvement (if [A and B] then [C or D]), of checking ([C or D] always TRUE) and of exclusion ([A and B] always FALSE) between terms.

Furthermore, the activity of consultation and prescription by a doctor, which is perceptible by means of a specialist business tool, for example a medical software related to one or more databases, is observed. The observed sequence of activity consists of actions taken by the doctor: adding information about a patient, choice of a treatment, exclusion of an antecedent. These information are entered as the consultation proceeds or are obtained from one or more patient databases.

These sequences of events are “projected” into the network of constraints, in other words the observed objects are confronted with the constraints corresponding to the modelling of the practical reference system. This confrontation can:

propagate constraints in the network from the observed objects,

detect errors (from a logical point of view, contradictions which are sources of errors) between the sequences of observed objects and the reference system translated into constraints.

These errors allow users to correct the reference system and/or the use of the software, in this case the sequence of observed events.

In one embodiment of the building method according to the invention, illustrated by FIG. 2, in response to a request for qualification of a practical reference system, for example the practice of preparing a contractual legal document, a first step is to build a reference system for this practice, for example the outline of a contract with its standard clauses. It then involves transforming this reference system into a network of constraints, such as compatibility constraints between legal clauses. The activity of a practitioner using the software tool to help in the drafting of a contract is then observed. This observation takes the practical form of data or information entry made by the user into a graphic interface devoted to this software tool.

A confrontation step between this activity and the constraints then follows, then an error detection step, where these are viewed on the graphic interface.

The process which has just been described is iterated while errors are detected between observation and constraints, which has the effect of acting again in the building of the practical reference system. This process can be automated easily to lead to the method for building the language for a knowledge base.

Certainly, the invention is not limited to the examples which have just been described and a variety of developments can be added to these examples without departing from the framework of the invention. In particular, an iterative process with a more or less complex iteration level can be stipulated. In addition, the businesses and knowledges involved in the method for building language according to the invention are not limited to those from the medical or legal sector, but can involve all fields of human activity if the objective is to design a tool for representing knowledge and helping with decisions or preparing a product.

1. Method for building a language for a knowledge base matched to the observation of facts in a system, in order to supply a software tool associated with said system, this method comprising:
a description by a user of a representation of said system, by constructing an ontology, said representation being based on a knowledge base,
a translation of this description into a network of constraints corresponding to instructions from the user,
an observation of objects and actions present in an actual environment of said system,
a confrontation of said observed objects with said instructions,
a detection of errors between the sequences of observed objects and the translation of the description into a network of constraints, and
an adaptation of the ontology or behaviour of said system so as to correct said errors,
said ontology thus adapted procuring for said user the knowledge base language.

2. Method according to claim 1, characterized in that the steps of description, translation and observation are iterated while the observed errors are outside an acceptable error state.

3. Method according to claim 1, implemented for the supply of a “business” software tool, characterized in that the description step comprises building a practical reference system.

4. Method according to claim 3, characterized in that the building of a practical reference system is accompanied by a definition of a semantic network consisting of terms, concepts and relationships.

5. Method according to claim 3, characterized in that the observation step comprises an entry of information in real time on a workstation for a user of said “business” software tool.

6. Method according to claim 3, characterized in that the observation step comprises a collection of information in one or more “business” databases.

7. Method according to claim 3, characterized in that the confrontation step comprises a propagation of constraints in the network from the observed objects.

8. System for building a language for a knowledge base matched to the observation of facts in a system, in order to supply a software tool associated with said system, implementing the method according to one of the preceding claims, comprising:
means for building, from a description of a representation of said system by a user, an ontology for the knowledge base,
means to translate this description into a network of constraints corresponding to instructions from the user,
means to observe objects and actions present in an actual environment of said system,
means to confront said observed objects with said instructions,
means to detect errors between the sequences of observed objects and the translation of the description into a network of constraints, and
means to adapt the ontology or behaviour of said system so as to correct said errors,
said ontology thus adapted procuring for said user the knowledge base language.
